(19) United States
(12) Patent Application Publication
(10) Pub. No.: US 2004/0203498 A1
(43) Pub. Date: Oct. 14, 2004

(54) Wireless user interface for remotely accessing a computer

(76) Inventor: Mao-Hsiang Kuo, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,516

(22) Filed: Jul. 23, 2002

(51) Int. Cl. H04B 1/38

(52) U.S. Cl. 455/90.3; 455/575.1

(57) ABSTRACT

A wireless user interface includes a wireless communications module for communicating with a computer, a display device for displaying output of the wireless communications module, a keyboard for interfacing with the wireless communications module, a hinge mechanically connecting the display device and the keyboard, and a power supply for supplying power. The display device and the keyboard can be relatively positioned using the hinge such that an angle between the keyboard and the display device is between 0 and 180 degrees so that a user is capable of using the display device and the keyboard simultaneously, and the keyboard can be positioned to face the display device so that a protective cover protects the display device.

### BACKGROUND OF INVENTION

1. Field of the Invention

The present invention relates to a computer user interface, and more specifically, to a wireless user interface for remotely accessing a computer.

2. Description of the Prior Art

As people spend an ever-increasing amount of time using computers, providing a practical and ergonomic computer user interface that is well adapted to the needs of the user is very important.

There are a large number of prior art computer user interfaces currently available. The most common of these is a desktop monitor, keyboard, and mouse combination for use with a desktop computer. While this style of user interface is indeed venerable, it is inconvenient, as a user must remain seated at a desk in order to use it. The user is constrained to fit the user interface, and this results in discomfort. Of course, notebook computers have improved this situation somewhat by allowing a user to take their computer, including all the necessary components, anywhere they want. While the notebook has advantages over the desktop in portability, it suffers from an associated higher price. Furthermore, the notebook computer requires the user to carry around all of the components necessary for the notebook computer to function.

Currently, a user wanting the low cost and high processing power of a desktop computer along with the portability of a notebook computer must purchase both of these two computer systems. Additional difficulty is also imposed on the user when the user wants to synchronize data between these two computer systems. Maintaining two separate computer systems can be a source of errors and besides, this takes a lot of energy. Furthermore, resources are wasted by the user by owning these two separate computer systems.

Therefore, the prior art lacks a conveniently portable user interface for a computer.

### SUMMARY OF INVENTION

It is therefore a primary objective of the claimed invention to provide a wireless user interface for remotely accessing a computer to solve the problems of the prior art.

Briefly summarized, the claimed invention includes a wireless communications module for communicating with a computer, a display device for displaying output of the wireless communications module, a keyboard for interfacing with the wireless communications module, a hinge mechanically connecting the display device and the keyboard, and a power supply for supplying power.

According to the claimed invention, a protective cover is disposed on a backside of the keyboard. The display device and the keyboard can be relatively positioned through the hinge such that a front side of the keyboard faces a display side of the display device so that the protective cover protects the display side of the display device, and an angle between the front side of the keyboard and the display side of the display device is between 0 and 180 degrees so that a user is capable of using the display device and the keyboard simultaneously.

It is an advantage of the claimed invention that the wireless communications module can access all of the functions of the computer thus allowing the claimed invention to be conveniently portable by a user due to the few number of total components therein. In other words, the claimed invention provides a fully functioning and light portable user interface for a stationary computer.

It is another advantage of the claimed Invention that the hinge can be used to fold the keyboard and display device combination such that the protective cover protects the display side of the display device.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a wireless user interface according to the present invention.

FIG. 2 is a perspective view of the wireless user interface of FIG. 1 shown closed.

FIG. 3 is a block diagram of the wireless user interface of FIG. 1 according to a first embodiment.

FIG. 4 is a block diagram of the wireless user interface of FIG. 1 according to a second embodiment.

### DETAILED DESCRIPTION

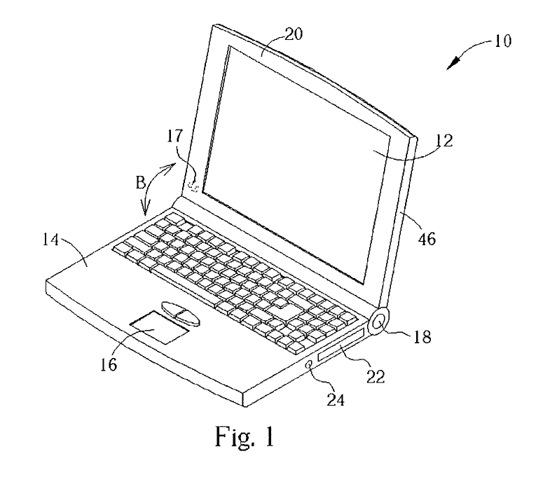

Referring to FIG. 1, a wireless user interface 10 includes a display device 12, which is a liquid crystal display (LCD), a keyboard 14 including a touch pad 16 having buttons, and a hinge 18 mechanically connecting the LCD 12 and the keyboard 14. The LCD 12, keyboard 14, touch pad 16, and hinge 18 are all respectively disposed in and on a housing 20. Also shown embedded in the housing 20 is a speaker 17. The hinge 18 allows the LCD 12 and keyboard 14 to be rotated with respect to each other so that an angle B is changed. The hinge 18 is designed so that the angle B can range from 0 to 180 degrees. When the angle B is 0 degrees the wireless user interface 10 is closed, and when the angle B is about 120 degrees the wireless user interface 10 is open as illustrated in FIG. 1. Naturally, the angle B can be varied by a user based on personal preference. The hinge 18 is also designed so that only a small external force, exerted by the user, is required to change the relative positions of the LCD 12 and the keyboard 14.

Also shown in FIG. 1 are a connection port 22 and a power port 24, and details of both will be given later. The locations of the connection port 22 and the power port 24 are not critical and are shown on the side of the keyboard 14 for illustrative purposes only. For instance, the connection port 22 could be located on the spine of the hinge 18 and the power port 24 could be located on the front edge of the keyboard 14.

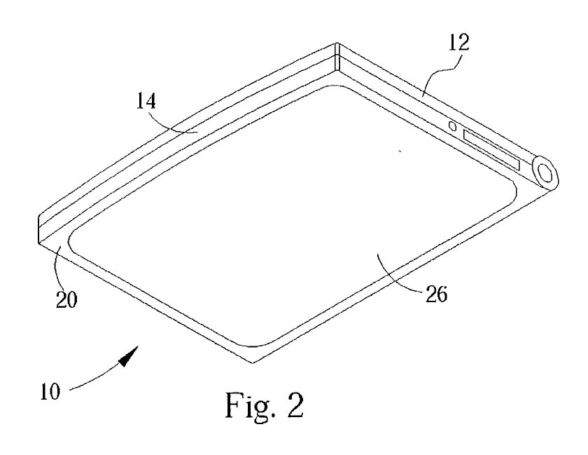

A perspective view of the wireless user interface 10 closed where angle B equals about 0 degrees is illustrated in FIG. 2. FIG. 2 clearly shows the housing 20 and a protective cover 26. The housing 26 can be made of plastic, metal, or any other material readily available to manufacturers of computer products. The protective cover 26 is disposed on a backside of the keyboard 14, and protects the LCD 12 from damage. The protective cover 26 is ideally made of a metal such as aluminum or titanium alloy, but can also be reinforced plastic or similar material. Additionally, a second protective cover (not shown) can be disposed on a backside of the LCD 12 to further protect to the LCD 12 from physical harm.

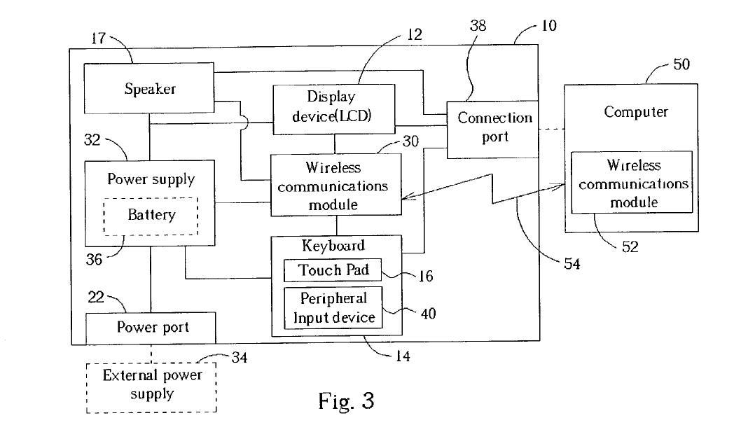

FIG. 3 is a block diagram of the wireless user interface 10. The wireless user interface 10 further comprises a wireless communications module 30, such as a wireless local area network (LAN) adapter complying with IEEE 802.11b, used to communicate with a similar wireless communications module 52 of a computer 50 via electromagnetic signals 54. The wireless communications module 30 is electrically connected to the LCD 12, the keyboard 14, speaker 17, and a power supply 32. The power supply 32 can receive power from an external power supply 34 via the power port 22 or from a battery 36, to power the wireless communications module 30, the LCD 12, and the keyboard 14. The battery 36 can be removable and rechargeable, and can receive recharge power from the external power supply 34. The wireless user interface 10 additionally comprises a connection port 38 that can be connected to a corresponding connection port of the computer 50 so that the wireless user interface 10 can communicate with the computer 50. The connection port 38 provides the same communication function as wireless communications module 30. Additionally, shown with the keyboard 14 is the touch pad 16 and a peripheral input device 40, which provides further input functionality and can be a device such as a mouse, fingerprint scanner, or similar input device.

When a user wishes to access the computer 50 from a physically remote location, the user first installs the charged battery 36 into the wireless user interface 10. The user then disconnects the connection port 38, if it is connected, from the computer 50. The user is now free to roam within the range of the wireless communications module 30 and access the computer 50. The user can control the computer 50 as usual using the keyboard 14, the touch pad 16, and the peripheral input device 40. The user is able to view the output of the computer 50 as it is transmitted through the wireless communications module 30 using the LCD 12. Audio output can also be listened to using the speaker 17. The wireless user interface 10 allows the user to access the processing power of the computer 50 and at the same time to freely move about and be comfortable.

If the user wants to access the computer 50 when it is nearby, the user can simply connect the connection port 38 to the computer 50 and then use the computer normally. As expected, the user can still wirelessly access the computer 50, as described above, when in the vicinity of the computer 50.

When the battery 36 becomes discharged due to use, the user either replaces the battery 36 with a fresh battery or connects the power port 22 to the external power supply 34. Additionally, if the user desires to recharge the battery 36, the user connects the power port 22 to the external power supply 34 with the battery 36 installed. The wireless user interface 10 can operate using power from the battery 36 or via the power port 22.

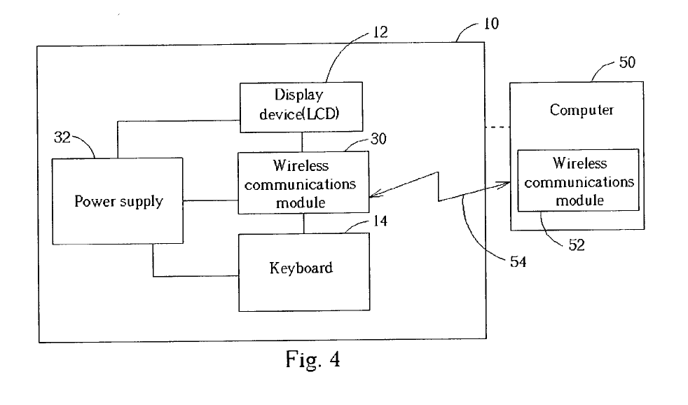

In its most basic form, the wireless user interface 10 requires the wireless communications module 30, the LCD 12, the keyboard 14, and the power supply 32. This second embodiment is shown in FIG. 4. The power supply 32, be it a battery or a another power source, powers the wireless communications module 30, the LCD 12, and the keyboard 14. The wireless communications module 30 communicates with the wireless communications module 52 of the computer 50 via electromagnetic signals 54. The LCD 12 displays output of the wireless communications module 30, which is in effect the output of the computer 50. The keyboard 14 allows the user to access the computer 50. The second embodiment of the wireless user interface 10 is utilized by the user in the same way as the preferred embodiment. Though the second embodiment has reduced functionality when compared with the preferred embodiment, it retains the advantages over the prior art.

In contrast to the prior art, the present invention allows a user to access a physically remote computer using a wireless communications module. The wireless communications module can access all of the functions of the computer thus allowing a display device and keyboard to provide a full function and lightweight portable user interface for a stationary computer. Furthermore, the hinge can be used to fold the keyboard and display device combination so that the protective covers protect the display device.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A wireless user interface for remotely accessing a computer, the wireless user interface comprising:
a wireless communications module for communicating signals between the wireless user interface and the computer;
a display device electrically connected to the wireless communications module, the display device having a display side on which output of the wireless communications module is displayed;
a keyboard electrically connected to the wireless communications module for interfacing with the wireless communications module;
a hinge for mechanically connecting the display device and the keyboard; and
a power supply for supplying power to the wireless communications module, the display device, and the keyboard.

2. The wireless user interface of claim 1 wherein the wireless communications module communicates signals over a wireless local area network (LAN).

3. The wireless user interface of claim 1 further comprising a protective cover disposed on a backside of the keyboard.

4. The wireless user interface of claim 3 wherein the display device and the keyboard are capable of being relatively positioned such that a front side of the keyboard faces the display side of the display device so that the protective cover protects the display side of the display device, and an angle between the front side of the keyboard and the display side of the display device is between 0 and 180 degrees so that a user is capable of using the display device and the keyboard simultaneously.

5. The wireless user interface of claim 1 wherein the keyboard comprises a touch pad.

6. The wireless user interface of claim 1 wherein the keyboard further comprises a peripheral input device.

7. The wireless user interface of claim 1 wherein the display device is a liquid crystal display (LCD) having a backside on which a protective cover is disposed.

8. The wireless user interface of claim 1 wherein the power supply comprises a removable rechargeable battery.

9. The wireless user interface of claim 1 wherein the power supply comprises a power port that connects to an external power source.

10. The wireless user interface of claim 1 further comprising a housing inside of which the wireless communications module, the display device, the keyboard, and the power supply are all disposed.

11. The wireless user interface of claim 1 further comprising a connection port that is capable of being connected to the computer for communicating signals between the wireless user interface and the computer.

12. The wireless user interface of claim 1 further comprising a speaker electrically connected to the wireless communications module for outputting audio information.
